(19) United States
(12) Patent Application Publication
(10) Pub. No.: US 2002/0126707 A1
(43) Pub. Date: Sep. 12, 2002

(54) System and method for rate adaptation in a wireless communication system

(76) Inventors: Marcus Tong, San Marcos, CA (US); Andreas Falkenberg, San Diego, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/924,620

(22) Filed: Aug. 7, 2001

Related U.S. Application Data
(60) Provisional application No. 60/274,542, filed on Mar. 8, 2001.

(51) Int. Cl. H04J 3/06

(52) U.S. Cl. 370/516; 370/429

(57) ABSTRACT

A rate adjustment scheme. Two pairs of slightly oversized buffers are utilized as jitter buffers. While a pair of buffers are dispensing and gathering audio input and audio output samples, another pair of buffers function as encoder/decoder input and output buffers. The input and output sample buffers work in sample based time scale by accepting and discharging one sample at a time. The encoder/decoder buffers are utilized in frame based scale where an entire block of samples is read or written for encoding or decoding. On every frame clock derived from an external source, the uplink buffers (i.e., the audio input and the encoder input buffers) are swapped. The downlink buffers (i.e., the audio output and the decoder output buffers) are also swapped. The rate adjustment takes place seamlessly in the act of buffer swapping.

### CROSS REFERENCE TO RELATED APPLICATIONS

This application claims priority from U.S. Provisional Application Serial No. 60/274,542, filed Mar. 8, 2001, which is hereby incorporated by reference in its entirety as if fully set forth herein.

### BACKGROUND OF THE INVENTION

1. Field of the Invention

The present invention relates to communication systems and, in particular, to an improved rate adaptation system and method.

2. Description of the Related Art

Telecommunications systems and devices, such as cellular telephones, must synchronize a plurality of clock sources. For example, in a cellular telephone, a local clock source may be used for sampling, analog-to-digital conversion, digital-to-analog conversion, and the like. However, transmitting and receiving, as well as coding, may be in response to a remotely derived clock source, i.e., a clock derived from a remote base station.

During voice communication, it is important that analog audio data be processed at a constant rate. The audio data rate must adjust between the local and remote clock domains. Failure to do so can result in uneven data packet separation, which can adversely affect voice quality.

A jitter buffer is often used to even out the packet separation. A jitter buffer is a modified (asynchronous) FIFO (first in, first out) buffer in which packets leave the buffer at a predetermined, constant rate. Minimizing the amount of actual rate adjustment is important to prevent unnecessary delays. Excessive buffering delays transmission output, while under-buffering causes gaps in the data. It is also important, however, to prevent data overflow in the buffer. cl SUMMARY OF THE INVENTION

These and other drawbacks in the prior art are overcome in large part by a system and method for rate adjustment according to embodiments of the present invention. A rate adjustment system according to an embodiment of the invention includes a first jitter buffer pair and a second jitter buffer pair. The buffers in the first and second jitter buffer pairs are swapped to effect a rate adjustment.

Two pairs of slightly oversized buffers are utilized as jitter buffers for seamless implementation of the rate adjustment scheme. While a pair of buffers are dispensing and gathering audio input and audio output samples, another pair of buffers function as encoder/decoder input and output buffers. The input and output sample buffers work in sample based time scale by accepting and discharging one sample at a time. The encoder/decoder buffers are utilized in frame based scale where an entire block of samples is read or written for encoding or decoding. On every frame clock derived from an external source, the uplink buffers (i.e., the audio input and the encoder input buffers) are swapped. The downlink buffers (i.e., the audio output and the decoder output buffers) are also swapped. The rate adjustment takes place seamlessly in the act of buffer swapping.

### BRIEF DESCRIPTION OF THE DRAWINGS

A better understanding of the invention is obtained when the following detailed description is considered in conjunction with the following drawings in which:

FIG. 1 is a diagram of telecommunications device according to an implementation of the invention;

FIG. 2 is a simplified functional block diagram of a telecommunication device according to an embodiment of the invention;

FIG. 3 illustrates jitter buffer operation according to an implementation of the invention;

FIG. 4 illustrates exemplary use of a jitter buffer according to an implementation of the invention; and

FIG. 5 illustrates exemplary use of a jitter buffer according to an implementation of the invention.

### DETAILED DESCRIPTION OF THE INVENTION

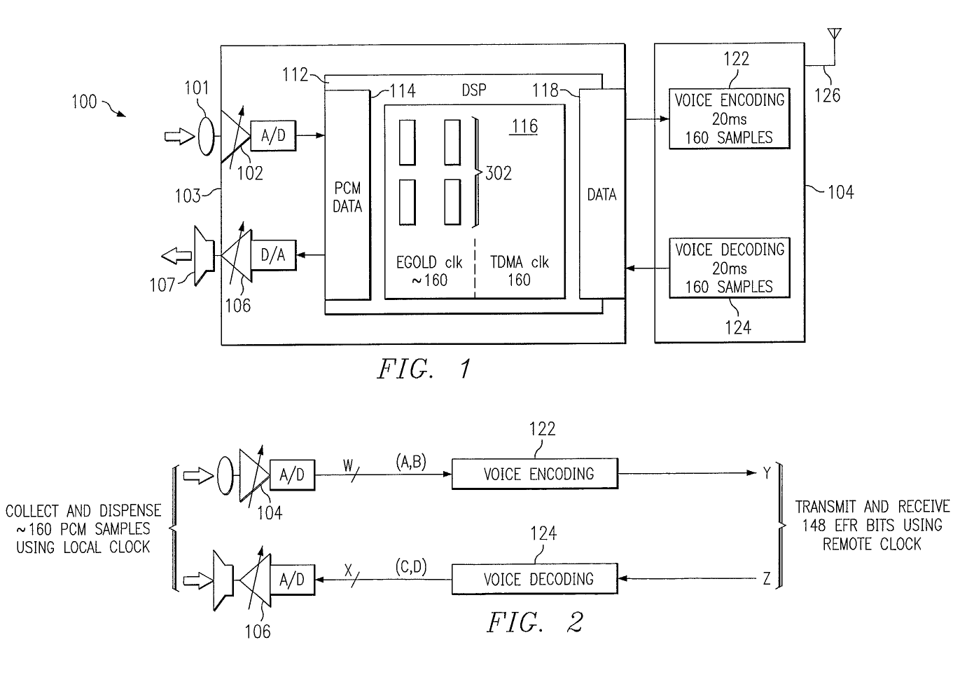

FIGS. 1-5 illustrate a rate adjustment system and method according to embodiments of the present invention. Turning now to FIG. 1, a block diagram of a telecommunications device according to an implementation of the invention is shown and generally identified by the reference numeral 100. In particular, the device 100 is representative of a mobile phone, including for example a GSM (Global System for Mobile Communications) or TDMA (Time Division Multiple Access, such as specified for TIA IS-136 or revised or related standards) telephone, or a GSM/TDMA multi-mode phone or other multi-mode phone. Voice data are received via a microphone 101 into an analog-to-digital converter 102. The converted data may be processed further, such as by PCM (pulse code modulation) conversion (not shown), and then provided to a digital signal processor 112.

As will be explained in greater detail below, the digital signal processor 112 may include a PCM interface 114, a data interface 118, and implements various firmware 116. The firmware 116 implements rate adjustment according to an embodiment of the invention and may also implement known functionality such as echo cancellation, and the like. The data are then provided to the vocoder 104. The vocoder 104 includes voice encoder 122 and voice decoder 124 and may also include other processing (not shown). The encoded signals are then transmitted via antenna 126. For GSM and/or TDMA multimode phones, phone 112 may include for example a GSM processor such as E-GOLD PMB 2850 GSM baseband system available from Infineon Technologies AG, and TDMA IS-136 chip such as PCI3610 available from Prairiecomm Inc. Of course, other processors and chips may be used.

The receive path is generally similar. Data are received at and decoded by the decoder 124. The data are transferred to the DSP 112. Again, the DSP 112 implements rate adjustment for the received data. The data are provided to the output via digital-to-analog converter 106, to a speaker 107.

As will be explained in greater detail below, in one embodiment, the vocoder 104 operates on speech frame of 20 milliseconds on a clock derived from an external source, such as a base station (not shown). On the PCM side, this corresponds to a block of 160 PCM samples at a sampling frequency of 8000 samples/second. The 160 sample block is analyzed by the encoder 122 to extract four sets of parameters producing a total of 148 ACELP (algebraic code excited linear prediction) bits for transmission, which may occur in a known manner. Similarly, the decoder 124 reconstructs 160 speech samples using a 20 millisecond frame of 148 receive bits in the opposite direction. The 20 millisecond frame with the 148 bits corresponds to a bit rate of 7400 bits/second on the PCM baseband side.

This is illustrated schematically with reference to FIG. 2. The 8000 samples/second codec sampling clock at W, X is provided by a local oscillator (not shown). The 20 millisecond frame clock at Y, Z is derived from an external source.

A rate adjustment scheme according to embodiments of the invention is employed because, as the two oscillators slip past one another, the 20 millisecond frame based on the remote clock can no longer enclose a fixed amount of 160 speech samples which are clocked in and out with the local oscillator.

The rate adjustment scheme is illustrated schematically and by way of example with reference to FIG. 3. The scheme is implemented in the PCM domain, at W, X in FIG. 2. The buffers 302a, 302b are provided in the transmit path, and the buffers 302c, 302d are provided in the receive path. The buffers 302a, 302c function as audio input and output buffers (to and from the microphone 101 and speaker 107). The buffers 302b, 302d function as transmit and receive input and output buffers to and from the DSP 112 (FIG. 1). In the embodiment illustrated, the buffers 302a, 302c function in the 8 kHz sample based time scale by accepting and dispensing one PCM sample at a time. The buffers 302b, 302d function in the 20 ms frame based scale, where the DSP either reads the whole 160 sample block for encoding or writes the whole block after decoding.

The buffers 302a-302d are somewhat larger than the 160 sample size to facilitate jittering for either a slower external clock or a fast local oscillator. For example, a re-adjusted buffer size of 165 samples may be employed. A block of 165 samples for a 20 millisecond frame corresponds to 8250 samples per second with a 3% slip. However, to accommodate additional slip, the buffer size can be increased. It is noted that these buffer and frame sizes are exemplary only.

In operation, rate adjustment is accomplished through swapping the buffers 302a, 302b and 302c, 302d. More particularly, on every 20 millisecond frame clock derived from the external source, the uplink buffers 302a, 302b are swapped and the downlink buffers 302c, 302d are swapped, as shown in FIG. 3. Thus, after the swap, the buffers 302b, 302d are the PCM audio input and output buffers, whereas the buffers 302a, 302c are the DSP input and output buffers.

The rate adjustment takes place seamlessly through the buffer swap. The DSP 112 uses a set amount of 160 samples regardless of how many new PCM samples are available in the newly swapped buffer. If more than 160 samples are available, then the extra samples at the bottom of the buffer are not used. Similarly, when the system encounters the opposite situation, leftover samples from the previous frame will be reused as the current 160 sample block. Thus, the rate adjustment scheme can adjust to both a fast or slow external clock.

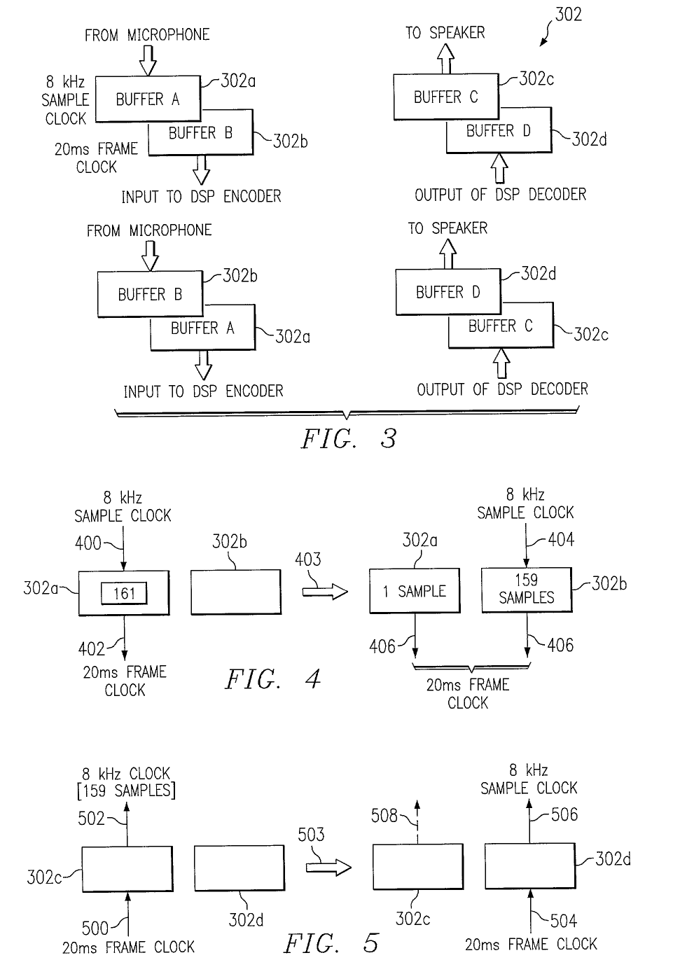

This is illustrated more clearly with reference to FIG. 4 and FIG. 5. FIG. 4 illustrates the use of buffers 302a, 302b. Shown are the buffers 302a, 302b. At 400, the PCM samples are clocked into the buffer 302a using the 8 kHz sample clock. In the example shown, the 8 kHz frame clock runs fast, and 161 samples are loaded into the buffer 302a during the 20 millisecond frame clock period. At the 20 millisecond frame clock expiration, at 402, the frame is input to the encoder and the buffers are swapped as shown at 403. However, the frame is only 160 samples, so the remaining sample is not transferred as part of the frame. Then, at 404, the PCM samples are clocked into the buffer 302b using the 8 kHz sample clock. In this example, however, the sample clock runs slow, so only 159 samples are loaded into the buffer 302b during the 20 millisecond frame period. Upon expiration of the 20 millisecond frame period, at 406, the frame is loaded to the DSP. At this point, however, all 159 samples in the buffer 302b, as well as the sample that was not transferred from the buffer 302a, are transferred as the frame. If no excess samples are available from the not-used buffer, then the frame would be transferred without the full 160 samples.

FIG. 5 illustrates use of the buffers 302c, 302d. As shown in the example, at 500, the 20 millisecond frame clock clocks a frame of 160 samples into the buffer 302c. During the next 20 milliseconds, the samples are clocked out using the 8 kHz sample clock, at 502. In the example shown, the sample clock runs slow, and only 159 samples are clocked out before expiration of the 20 millisecond frame. At 503, the buffers are swapped and another frame is clocked into buffer 302d, at 504. This time, the sample clock runs fast, and 161 samples are clocked out. However, because the frame has only the 160 samples clocked in at the 20 millisecond mark, the remaining sample from the not used buffer 302c is clocked out to make up the difference. If the sample clock ever outran the 20 millisecond frame clock and there were no samples to make up the difference, only zeroes would be transferred. It is noted that, while discussed separately with reference to FIG. 4 and FIG. 5, in operation, the buffer swapping of both buffers occurs simultaneously.

As noted above, in one embodiment, the above-described buffers are implemented as DSP firmware. In one such embodiment, an initial step is to define four 16 bit (1 word) wide pointers and four 165 word-length buffers: PCM_IN, PCM_OUT, DSP_IN, DSP_OUT, VB_BUFF_A, VB_BUFF_B, VB_BUFF_C, VB_BUFF_D.

In an initialization step, the four pointers PCM_IN, PCM_OUT, DSP_IN, DSP_OUT are assigned to the top of a buffer TOP_VB_BUFF_A, TOP_VB_BUFF_B, TOP_VB_BUFF_C, TOP_VB_BUFF_D, respectively. The buffers VB_BUFF_A, VB_BUFF_B, VB_BUFF_C, VB_BUFF_D then are initialized with a value representing a PCM value of zero.

Then, interrupts are initialized and a main routine MAIN is called. The MAIN routine is any routine adequate to implement the processing required, such as TDMA or GSM processing.

In one embodiment, the data transfer to and from the jitter buffers is handled by one or more interrupt service routines: PCM 8 kHz Service Routine and 20 millisecond Interrupt Service Routine.

When the PCM 8 kHz Service Routine is called, every 8 KHz, 1 uplink PCM data is fetched from the VBDIN register 110a, and one downlink PCM data is written to the VBDOUT register 110b. The PCM_OUT pointer is incremented. The routine then returns to the main program.

When the 20 millisecond Interrupt Service Routine is called every 20 milliseconds, the system reads and stores 160 downlink samples to the buffer pointed by DSP_OUT, and writes 160 uplink encoder samples from the buffer pointed by DSP_JIN. In addition, the buffers are swapped as discussed above by reassigning pointers:

PCM_IN =TOP_VB_BUF_B

DSP_IN =TOP_VB_BUF_A

PCM_OUT =TOP_VB_BUF_D

DSP_OUT =TOP_VB_BUF_C

The routine then begins the next 20 ms frame count and returns to the main program.

The invention described in the above detailed description is not intended to be limited to the specific form set forth herein, but is intended to cover such alternatives, modifications and equivalents as can reasonably be included within the spirit and scope of the appended claims.

What is claimed is:

1. A system, comprising:
first circuitry in a first clock domain operable at a first clock frequency;
second circuitry in a second clock domain operable at a second clock frequency;
first and second jitter buffer pairs interfacing between said first circuitry and said second circuitry domain, said first jitter buffer pair comprising first and second jitter buffers, and said second jitter buffer pair comprising third and fourth jitter buffers;
wherein said first or second jitter buffers and said third or fourth jitter buffers alternately fill at said first clock frequency and empty at said second clock frequency, wherein alternation between said first and second jitter buffers and said third and fourth jitter buffers occurs at said second clocking frequency.

2. A system in accordance with claim 1, said first circuitry comprising an audio input, said second circuitry comprising an encoder.

3. A system in accordance with claim 1, said first circuitry comprising an audio output, said second circuitry comprising a decoder.

4. A system in accordance with claim 2, said first clock frequency comprising a sample clock, said second clock frequency comprising a frame clock.

5. A telecommunication system, comprising:
an audio input;
an audio output;
interface circuitry comprising first and second jitter buffers operably coupling said audio input to a voice encoder and third and fourth jitter buffers operably coupling said audio output to a voice decoder;
wherein said first or second jitter buffers alternately fill at a first clock frequency and empty at a second clock frequency, wherein alternation between said first and second jitter buffers occurs at said second clock frequency; and
wherein said third or fourth jitter buffers alternately fill at said second clock frequency and empty at said first clock frequency, wherein alternation between said third and fourth jitter buffers occurs at said second clock frequency.

6. A system in accordance with claim 5, said interface circuitry comprising one or more digital signal processors.

7. A system in accordance with claim 6, said first clocking frequency comprising a PCM sample clock frequency.

8. A system in accordance with claim 7, said second clock frequency comprising a frame clock frequency.

9. A system in accordance with claim 8, wherein a frame comprises 160 samples.

10. A system in accordance with claim 9, wherein a size of said first, second, third, and fourth buffers is 165 samples.

11. A method for rate adjustment using first and second jitter buffers, said first and second jitter buffers adapted to receive a plurality of samples at a first clock rate and transmit a block of said samples at a second clock rate, comprising:
switching between using said first or second jitter buffers at said second clock rate.

12. A method in accordance with claim 11, further including third and fourth jitter buffers, adapted to receive blocks of samples at said second clock rate and transmit a plurality of samples at said first clock rate, comprising:
switching between using said third or fourth jitter buffers at said second clock rate.

13. A method for rate adjustment, comprising:
receiving at first or second jitter buffers a plurality of samples at a first clock rate and transmit a block of said samples at a second clock rate; and
switching between using said first or second jitter buffers at said second clock rate.

14. A method in accordance with claim 13, further comprising:
receiving at third or fourth jitter buffers blocks of samples at said second clock rate and transmitting a plurality of samples at said first clock rate; and
switching between using said third or fourth jitter buffers at said second clock rate.

15. A method, comprising:
providing first circuitry in a first clock domain operable at a first clock frequency;
providing second circuitry in a second clock domain operable at a second clock frequency;
providing first and second jitter buffers interfacing between said first circuitry and said second circuitry domain;
wherein said first or second jitter buffers alternately fill at said first clock frequency and empty at said second clock frequency, wherein alternation between said first and second jitter buffers occurs at said second clocking frequency.

16. A method in accordance with claim 15, said first circuitry comprising an audio input, said second circuitry comprising an encoder.

17. A method in accordance with claim 15, said first circuitry comprising an audio output, said second circuitry comprising a decoder.

18. A method in accordance with claim 16, said first clock frequency comprising a sample clock, said second clock frequency comprising a frame clock.

19. A system, comprising:
first circuitry in a first clock domain operable at a first clock frequency;
second circuitry in a second clock domain operable at a second clock frequency;
first and second pairs of jitter buffers interfacing between said first circuitry and said second circuitry domain;
wherein ones of said pairs of first or second jitter buffers are swapped according to a clock by which said ones of said pairs of first or second jitter buffers are filled or emptied.

20. A system in accordance with claim 19, wherein said system is in a GSM/TDMA multi-mode phone.
